(19) United States
(12) Patent Application Publication
(10) Pub. No.: US 2017/0023726 A1
(43) Pub. Date: Jan. 26, 2017

(54) GLASS PLATE FOR LIGHT GUIDE PLATE

(71) Applicant: Asahi Glass Company, Limited, Chiyoda-ku (JP)

(72) Inventors: Naoya WADA, Chiyoda-ku (JP); Yusuke ARAI, Chiyoda-ku (JP); Hiroyuki HIJIYA, Chiyoda-ku (JP)

(73) Assignee: Asahi Glass Company, Limited, Chiyoda-ku (JP)

(21) Appl. No.: 15/286,208

(22) Filed: Oct. 5, 2016

Related U.S. Application Data
(63) Continuation of application No. PCT/JP2015/063651, filed on May 12, 2015.

(30) Foreign Application Priority Data
May 19, 2014 (JP) 2014-103564

(51) Int. Cl. F21V 8/00; C03C 3/11; C03C 3/085; C03C 3/083; C03C 3/087

(52) U.S. Cl. CPC G02B 6/0053; C03C 3/083; C03C 3/087; C03C 3/085; G02B 6/0058; C03C 3/11

(57) ABSTRACT

A glass plate for a light guide plate includes a light emitting surface; and a light scattering surface that is opposite to the light emitting surface, wherein a refractive index distribution is provided between the light emitting surface and the light scattering surface in a plate thickness direction, and wherein a refractive index calculated from a measured value of reflectance of the light scattering surface is greater than a refractive index of an inner part of the glass plate measured by a V block method after each of the light emitting surface and the light scattering surface is polished and removed by 100 microns.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2015/063651 filed on May 12, 2015 and designating the U.S., which claims priority of Japanese Patent Application No. 2014-103564 filed on May 19, 2014. The entire contents of the foregoing applications are incorporated herein by reference.

### BACKGROUND OF THE INVENTION

1. Field of the Invention

The present disclosure relates to a glass plate for a light guide plate, which is used for a liquid crystal display.

2. Description of the Related Art

A liquid crystal display includes a liquid crystal panel; a glass plate, as a light guide plate facing the liquid crystal panel; and a light source for irradiating light onto the liquid crustal panel through the glass plate (cf. Patent Document 1 (Japanese Unexamined Patent Publication No. 2004-252383, for example). Light from the light source enters an inner part from an edge surface of the glass plate; repeats surface reflection so as to spread over the whole inner part; and exits from a counter surface of the glass plate facing the liquid crystal panel, so that the liquid crystal panel is uniformly illuminated.

Brightness of the light from the light guide plate has been low.

There is a need for a glass plate for a light guide plate such that the brightness of the light from the light guide plate is enhanced.

### SUMMARY OF THE INVENTION

According to an aspect of the present invention, there is provided a glass plate for a light guide plate including a light emitting surface; and a light scattering surface that is opposite to the light emitting surface, wherein a refractive index distribution is provided between the light emitting surface and the light scattering surface in a plate thickness direction, and wherein a refractive index calculated from a measured value of reflectance of the light scattering surface is greater than a refractive index of an inner part of the glass plate measured by a V block method after each of the light emitting surface and the light scattering surface is polished and removed by 100 microns.

According to an embodiment of the present invention, a glass plate for a light guide plate can be provided such that brightness of light from the light guide plate is enhanced. Other objects, features and advantages of the present invention will become more apparent from the following detailed description when read in conjunction with the accompanying drawings.

### BRIEF DESCRIPTION OF THE DRAWINGS

FIG. 1 is a diagram illustrating a liquid crystal display according to an embodiment of the present invention;

FIG. 2 is a diagram illustrating an example of an optical spectrum of a white LED that is formed of a blue LED and a yellow fluorophore;

FIG. 3 is a diagram illustrating an example of an optical spectrum of a white LED that is formed of a blue LED, a green fluorophore, and a red fluorophore;

FIG. 4 is an illustration diagram of a float method, as a method of forming a glass plate for a light guide plate according to the embodiment of the present invention;

FIG. 5 is a diagram illustrating a structure of the glass plate for the light guide plate according to the embodiment of the present invention;

FIG. 6 is a diagram illustrating an example of a simulation analysis model; and

FIG. 7 is a diagram illustrating an example of a transmission spectrum used for a simulation analysis.

### DESCRIPTION OF THE PREFERRED EMBODIMENTS

An embodiment for implementing the present invention is described below by referring to the accompanying drawings. In the drawings, the same or corresponding reference numerals are attached to the same or corresponding configurations, and thereby the descriptions are omitted. In the present specification, the expression “from x to y,” which represents a numerical range, is defined to be a range including the numerical values x and y, which are the lower limit and the upper limit, respectively.

FIG. 1 is a diagram illustrating a liquid crystal display according to the embodiment of the present invention. The liquid crystal display includes a liquid crystal panel 10; a glass plate 20, as a light guide plate facing the liquid crystal panel 10; and a light source 30 that irradiates light onto the liquid crystal panel 10 through the glass plate 20.

The liquid crystal panel 10 is formed of, for example, an array substrate; a color filter substrate; a liquid crystal layer; and so forth. The array substrate is formed of a substrate; an active element (e.g., a thin film transistor (TFT)) that is formed on the substrate; and so forth. The color filter substrate is formed of a substrate; a color filter that is formed on the substrate; and so forth. The liquid crystal layer is formed between the array substrate and the color filter substrate.

The glass plate 20 is opposite to the liquid crystal panel 10. The glass plate 20 is located behind the liquid crystal panel 10. A surface 13 (rear surface) opposite to a display surface (front surface) 11 of the liquid crystal panel 10 and a front surface 21 of the glass plate 20 are arranged to be parallel.

On a rear surface 23 of the glass plate 20, a scattering structure, such as dots, is formed so as to extract light from the light guide plate. For a case where the scattering structure is the dots, each of the dots 40 may include air bubbles or particles for scattering. Instead of the dots 40, the rear surface 23 of the glass plate 20 may be processed to have a concavo-convex shape; or a plurality of lenses may be formed on the rear surface 23 of the glass plate 20.

The rear surface 23 of the glass plate 20 is parallel to the front surface 21 of the glass plate 20.

The light source 30 irradiates light onto an edge surface 26 of the glass plate 20. The light from the light source 30 enters an inner part from the edge surface 26 of the glass plate 20; repeats surface reflection so as to spread over the entire inner part; and exits from the counter surface (the front surface) 21 of the glass plate 20 facing the liquid crystal panel 10, so that the liquid crystal panel 10 is uniformly illuminated from behind. Between the glass plate 20 and the liquid crystal panel 10, a scattering film, a brightness enhancement film, a reflection type polarizing film, a 3D film, a polarizing plate, and so forth may be located. Behind the glass plate 20, a reflection film may be located, for example. The light source 30, the glass plate 20, and the various types of optical films are collectively referred to as a backlight unit.

As the light source 30, a white LED is used, for example. The white LED may be formed of, for example, a blue LED; and a fluorophore that illuminates in response to receiving light from the blue LED. As the fluorophores, there are that of YAG-based; an oxide; aluminate; nitride; oxynitride; sulfide; oxysulfide; rare earth oxysulfide; halophosphate; chloride, and so forth.

For example, the white LED may be formed of the blue LED; and a yellow fluorophore. Alternatively, the white LED may be formed of the blue LED; a green fluorophore; and a red fluorophore. The light from the latter white LED is obtained by mixing the three primary colors of light, so that the light from the latter white LED is superior in a color rendering property.

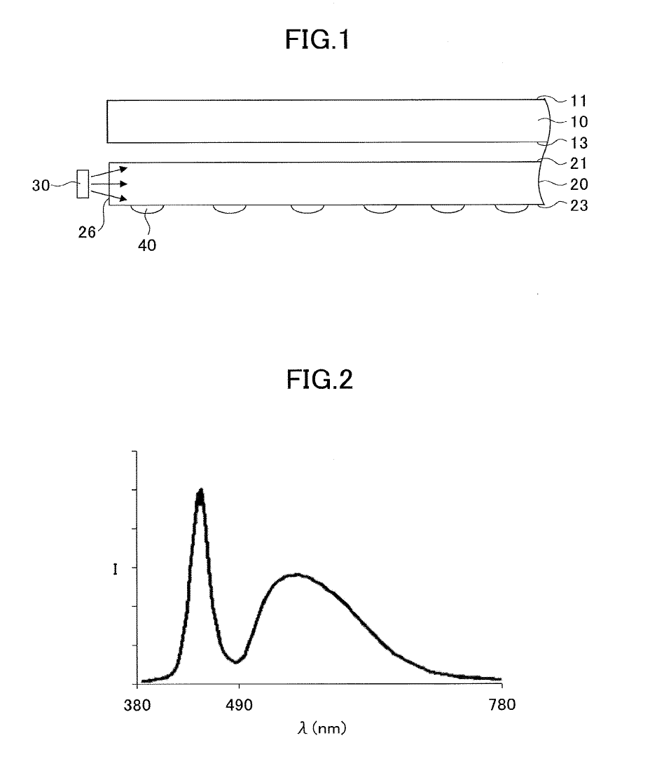

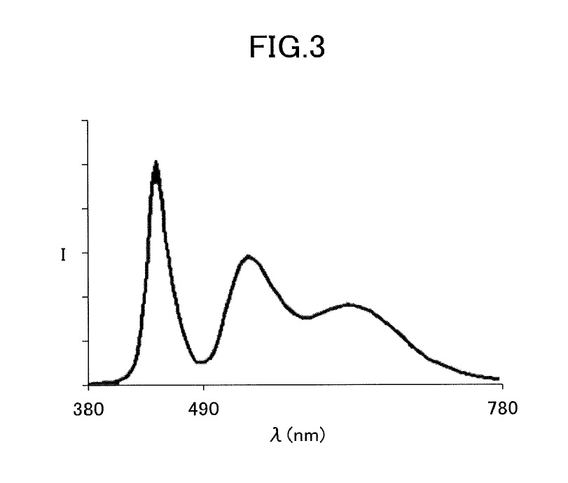

FIG. 2 is a diagram illustrating an example of an optical spectrum of the white LED that is formed of the blue LED and the yellow fluorophore. FIG. 3 is a diagram illustrating an example of an optical spectrum of the white LED that is formed of the blue LED, the green fluorophore, and the red fluorophore. In FIGS. 2 and 3, the horizontal axis indicates a wavelength (nm), and the vertical axis indicates intensity I.

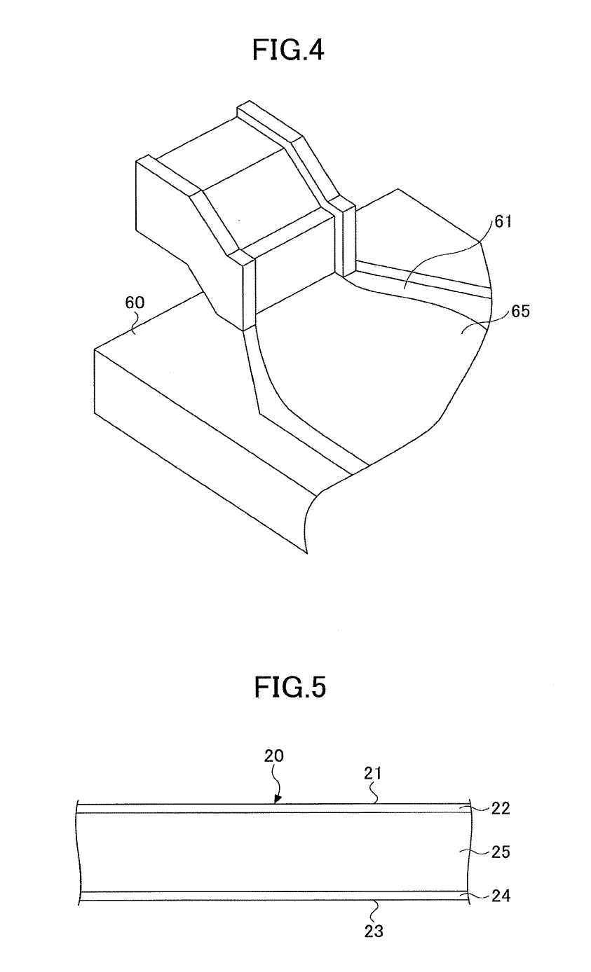

FIG. 4 is an illustration diagram of a float method, as a method of forming a glass plate for a light guide plate according to the embodiment of the present invention. FIG. 5 is a diagram illustrating a structure of the glass plate for the light guide plate according to the embodiment of the present invention.

As illustrated in FIG. 4, in the float method, a melted glass 65 that is continuously supplied onto a melted metal (e.g., melted tin) 61 in a tub 60 is caused to flow on the melted metal 61, so that the melted glass 65 is molded to be a glass ribbon having a band plate shape. The glass ribbon is gradually solidified, while the glass ribbon flows in a downstream direction. The solidified glass ribbon is retrieved from the melted metal 61, and is horizontally conveyed on a plurality of conveyance rollers located inside an annealing furnace. In order to suppress damage on the glass ribbon by the conveyance rollers, nozzles for spraying SO₂ gas onto the glass ribbon may be provided in the annealing furnace. The SO₂ gas forms a sodium sulfate film, such as that of a sulfur compound, on the surface of the glass ribbon. The glass ribbon that is taken out from the annealing furnace is cut into a desired size; and, subsequently, the cut glass ribbon is polished, depending on necessity, and is used as the glass plate 20. The sodium sulfate film can be removed by washing.

As illustrated in FIG. 5, the glass plate 20 that is formed by the float method may have a three layer structure formed of a first glass layer 22 including the front surface 21; a second glass layer 24 including the rear surface 23; and an intermediate glass layer 25 that is formed between the first glass layer 22 and the second glass layer 24.

The first glass layer 22 includes the front surface 21 (which is also referred to as a light emitting surface 21, hereinafter), as a light emitting surface. The first glass layer 22 is a layer in which an alkaline component is decreased, due to formation of the sodium sulfate film. The first glass layer 22 is formed to have a certain depth from a top surface (the upper surface) of the glass ribbon at the time of molding; and the alkaline component becomes insufficient, as the position becomes closer to the top surface. Consequently, a refractive index of the first glass layer 22 becomes small, as the position becomes closer to the top surface. The depth of the first glass layer 22 is determined by measuring, by a secondary ion mass spectroscopy, a depth of a layer where the alkaline components are insufficient. In general, the depth of the first glass layer 22 is sufficiently smaller than 100 microns.

The second glass layer 24 includes the rear surface 23 (which is also referred to as a light scattering surface 23, hereinafter), as the light scattering surface. The second glass layer 24 is a layer that is contaminated by contacting the melted metal 61. The second glass layer 24 is formed to have a certain depth from the bottom surface (the lower surface) of the glass ribbon at the time of molding; and the melted metal component increases, as the position becomes closer to the bottom surface. Consequently, a refractive index of the second glass layer 24 becomes large, as the position becomes closer to the bottom surface. The depth of the second glass layer 24 is determined by measuring, by the secondary ion mass spectroscopy, a depth of a layer where the melted metal component penetrates into. In general, the depth of the second glass layer 24 is sufficiently smaller than 100 microns. Note that, similar to the first glass layer 22, the second glass layer 24 is affected by formation of the sodium sulfate film; however, the effect by contacting the melted metal 61 is more significant than the effect of the formation of the sodium sulfate film.

The intermediate glass layer 25 is formed between the first glass layer 22 and the second glass layer 24. The intermediate glass layer 25 is not affected by the formation of the sodium sulfate film, nor by contacting the melted metal 61. Consequently, the intermediate glass layer 25 has a uniform refractive index in the plate thickness direction. Note that the intermediate glass layer 25 may have a slight refractive index distribution, such as a ream; however, if the variation of the refractive index distribution is less than 0.0005, the refractive index distribution can be regarded as almost uniform, so that, as the light guide plate, the effect on the brightness is small.

Note that, for comparing the refractive indexes of the respective layers, the refractive indexes may be represented by refractive indexes calculated from reflectance for a wavelength 587.6 nm at room temperature; or may be represented by refractive indexes for the d-line of helium (the wavelength is 587.6 nm) at the room temperature.

The glass plate 20 has a refractive index distribution between the light emitting surface 21 and the light scattering surface 23 in the plate thickness direction.

In the glass plate 20, the light emitting surface 21 is provided in the first glass layer 22; and the refractive index of the light emitting surface 21 is smaller than the refractive index of the intermediate glass layer 25 (which is also referred to as an internal glass plate, hereinafter). Thus, compared to a case where the first glass layer 22 is removed by polishing, namely, compared to a case where the intermediate glass layer 25 is exposed, instead of the first glass layer 22, the difference between the refractive index of the light emitting surface 21 and the refractive index of the air is small. Consequently, reflection on the light emitting surface 21 toward inside can be suppressed, so that light extraction efficiency (brightness) from the light emitting surface 21 to the outside is favorable.

The refractive index of the light emitting surface 21 can be adjusted by an amount of SO₂ gas which is sprayed during annealing. As the amount of SO₂ gas which is sprayed increases, the refractive index of the light emitting surface 21 becomes small. Note that the refractive index of the light emitting surface 21 can be lowered by spraying a gas or a liquid of a fluorine compound, such as F₂ and HF. Here, a part of the first glass layer 22 may be removed by polishing.

In the glass plate 20, the light scattering surface 23 is provided in the second glass layer 24; and the refractive index of the light scattering surface 23 is greater than the refractive index of the intermediate glass layer 25 (the internal glass plate). Thus, compared to a case where the second glass layer 24 is removed by polishing, namely, compared to a case where the intermediate glass layer 25 is exposed, instead of the second glass layer 24, light tends to travel straight ahead in the vicinity of the light scattering surface 23. The reason is that, if an incident angle of light is the same, and the refractive angle of the light by the second glass layer 24 and the refractive angle of the light by the intermediate glass layer 25 are compared, the refractive angle of the light by the second glass layer 24 is the smallest. Light that travels in the second glass layer 24 spreads over the entire inner part with a small traveling distance, and the direction of the light is changed, for example, by the reflection dot 40, almost without being absorbed by the glass, and the light is extracted from the light emitting surface 21. Therefore, light extraction efficiency from the glass plate (brightness) can be enhanced.

The refractive index of the light scattering surface 23 can be adjusted, for example, by the temperature during molding. As the temperature during molding becomes higher, diffusion of the melted metal 61 into the glass is promoted, and the refractive index of the light scattering surface 23 becomes large. Here, a part of the second glass layer 24 may be removed by polishing.

A refractive index n(λ) for a wavelength λ on a surface to be measured (the light emitting surface 21, and the light scattering surface 23) is calculated from a measured value R(λ) of the reflectance at room temperature by using the following formula (1):

n(λ)={1+R(λ)+(4×R(λ))^{1/2}}/(1−R(λ)) (1)

Here, R(λ) is the reflectance of the light with an incident angle of 5 degrees with respect to the surface to be measured, and glass at 25° C. is measured by a spectrophotometer. Note that, in order to prevent reflection on a surface opposite to the surface to be measured, the surface opposite to the surface to be measured is roughened by abrasive grains with a grain size #80, and the measurement is performed after the roughened surface is uniformly coated with a blackbody coating material. Here, the reflectance of the light scattering surface 23 is measured after the scattering structure, such as the dots 40, is removed by an organic solvent; or the reflectance of the light scattering surface 23 is measured on a flat glass surface on which the scattering structure is not formed yet. For a case where the flat glass surface is so small that it is difficult to perform measurement by the spectrophotometer, the reflectance may be measured by irradiating a laser beam onto the flat glass surface. Alternatively, the reflectance may be measured by the spectrophotometer in a state prior to forming the scattering structure, such as the dots. For comparing the refractive indexes of the respective layers, the refractive indexes are represented by the refractive indexes that are calculated from the measured values of the reflectance at the wavelength 587.6 nm. Further, for the refractive index n′(λ) of the internal glass plate (the refractive index of the intermediate glass layer 25) is measured by measuring, after polishing and removing each of the light emitting surface 21 and the light scattering surface by 100 microns, refractive indexes for wavelengths of g-ray (wavelength is 435.8 nm), F-ray (wavelength is 486.1 nm), e-ray (wavelength is 546.1 nm), d-ray (wavelength is 587.6 nm), and C ray (wavelength is 656.3 nm) by the V block method by using, for example, a precision refractometer KPR-2000, which is produced by Shimazu Corporation, at room temperature. For comparing the refractive indexes of the respective layers, the refractive indexes are represented by the refractive indexes for d-ray (wavelength is 587.6 nm) of helium at room temperature. Note that the refractive index measured by the V block method favorably agrees with the refractive index calculated from the measured value of the reflectance. For obtaining the refractive index of the internal glass plate from the reflectance, there is a method such that the glass surface layer is polished and removed by abrasive grains #1000 by 100 microns; subsequently, the glass surface layer is polished with free abrasive grains of colloidal silica or a cerium oxide until a mirror surface with Ra that is less than or equal to 0.03 μm is obtained; further, the rear surface is roughened by abrasive grains with a grain size #80; the rear surface is uniformly coated with the blackbody coating material; and then measurement is performed. However, this method is complicated. Further, due to existence of a ream, for example, the intermediate glass layer 25 may have a slight refractive index distribution; however, the measurement by the V block method is suitable also in a point that average information of the refractive index distribution of the object to be measured is obtained.

Next, simulation analysis of the brightness of the light from the glass plate 20 is described. For the simulation analysis, optical ray tracing software (Light Tools: Produced by CYBERNET SYSTEMS CO., LTD.) was used.

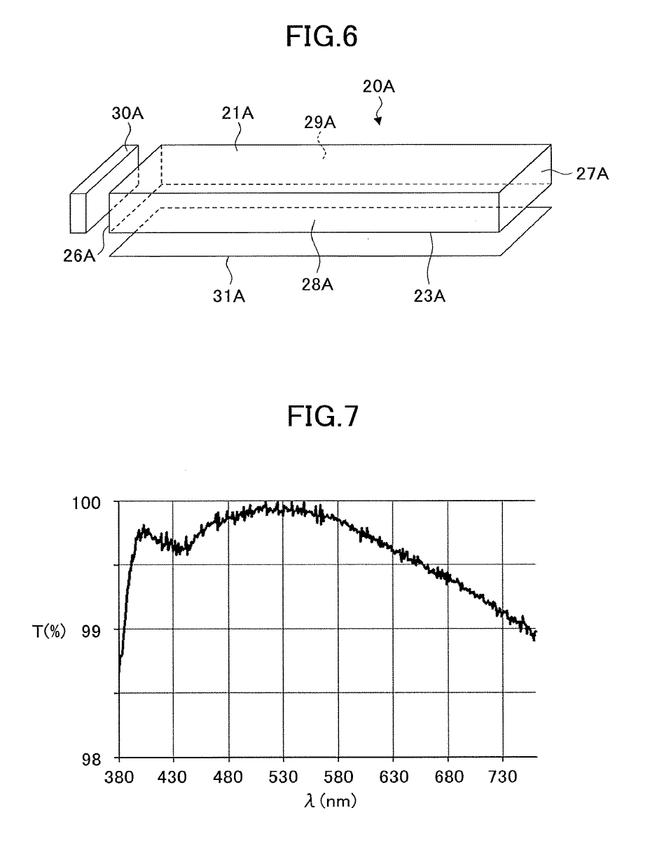

FIG. 6 is a diagram illustrating an example of a simulation analysis model. In this model, it was assumed that the glass plate 20A includes, similar to the glass plate 20 illustrated in FIG. 5, a three layer structure formed of a first glass layer, a second glass layer, and an intermediate glass layer. In this model, it was assumed that the size of the glass plate 20A is 10 mm×600 mm, and that the thickness of the glass plate 20 A is 2 mm; however, the tendency of the simulation result does not depend on the size and the thickness.

It was assumed that a boundary surface between the first glass layer and the intermediate glass layer, and a boundary surface between the second glass layer and the intermediate glass layer were surfaces without causing Fresnel reflection. For the simulation analysis, the refractive index discontinuously varies in the vicinities of these boundary surfaces, due to simplification of the model; however, in fact, the refractive index continuously varies. Consequently, Fresnel reflection does not occur, in fact, in the vicinities of these boundary surfaces.

A surface light source 30A, which was parallel to an edge surface 26A, was provided at a position separated, by 1 mm, from the edge surface 26A, which was one of mutually parallel edge surfaces 26A and 27A (the size was 2 mm×10 mm, and the distance was 600 mm) of the glass plate 20A. Note that, for a case where a plurality of point light sources are arranged, instead of adopting the surface light source as the light source, the tendency of the result does not change.

As the optical spectrum of the surface light source 30A, the optical spectrum of the white LED was used, which was formed of the blue LED, the red fluorophore, and the green fluorophore. It was assumed that the number of rays entering the edge surface 26A of the glass plate 20A from the surface light source 30A was 250,000. Note that, even if an optical spectrum of a different type of light source is used, the tendency of the result does not change.

Transmittance of the glass plate 20 was calculated based on a measured value (cf. FIG. 7) of internal transmittance (the transmission distance was 10 mm), which was obtained from an actual measurement value, and a traveling distance of each ray. FIG. 7 is a diagram illustrating an example of a transmission spectrum (the transmission distance was 10 mm) that was used for simulation analysis. In FIG. 7, the horizontal axis represents a wavelength λ (nm), and the vertical axis represents internal transmittance T (%).

The reflectance of light on the edge surface 27A, and left and right side surfaces 28A and 29A of the surfaces of the glass plate 20A was assumed to be 98%, as it was assumed that a reflective tape with reflectance of 98% was pasted on these surfaces. Then, convex lenses were arranged on the light scattering surface 23A in a hexagonal lattice shape, so that the light was uniformly extracted from the light emitting surface 21A; and the sizes of the convex lenses were set such that, as the distance from the surface light source 30A became greater, the size of the convex lens became greater. Additionally, a light reflecting surface 31A (reflectance 98%), which was parallel to the light scattering surface 23A, was provided at a position separated from the light scattering surface 23A by 0.1 mm. The light reflecting surface 31A reflects the light transmitted through the light scattering surface 23A toward the light scattering surface 23A. Note that the light reflecting surface 31A corresponds to a reflection sheet in the backlight unit.

Note that in the following tables, t₁ is the thickness of the first glass layer, t₂ is the thickness of the second glass layer, t₃ is the thickness of the intermediate glass layer, n₁ is the refractive index of the first glass layer, n₂ is the refractive index of the second glass layer, and n₃ is the refractive index of the intermediate glass layer. For simplicity of the model, it was assumed that the refractive index of each layer was uniform, and that the refractive index of each layer was the same for all wavelengths of visible light. The differences in the refractive indexes (n₁−n₃, n₂−n₃) were assumed to be the values indicated in the respective tables. Note that, even if the variance of the refractive index is considered, the tendency of the result does not change.

Table 1 and Table 2 indicate a brightness ratio L/L0 of the light from the glass plate 20A for a case where the thickness t₂ of the second glass layer is assumed to be zero, namely, for a case where the second glass layer does not exist. The brightness L of the light from the glass plate 20A is average brightness of the rays with respective wavelengths extracted from the light emitting surface 21A of the first glass layer. The brightness ratio L/L0 is a normalized value obtained by setting the brightness L0 to be 1 for a case where the refractive index of the first glass layer is the same as the refractive index of the intermediate glass layer (n₁=n₂). The refractive index n₃ of the intermediate glass layer is set to be 1.520 for all wavelengths of the visible light.

TABLE 1

| | | | | | | |
|---|---|---|---|---|---|---|
| n₁ − n₃ | 0.0000 | −0.0005 | −0.0010 | −0.0050 | −0.0100 | −0.0200 |
| t₁/(t₁ + t₃) | 0.0005 | 0.0005 | 0.0005 | 0.0005 | 0.0005 | 0.0005 |
| L (1x) | 30664.61 | 30676.81 | 30683.09 | 30777.25 | 30772.08 | 30814.27 |
| L/L0 | 1.000000 | 1.000398 | 1.000603 | 1.003673 | 1.003505 | 1.004880 |

TABLE 2

| | | | | | | | |
|---|---|---|---|---|---|---|---|
| n₁ − n₃ | 0.0000 | −0.0005 | −0.0010 | −0.0050 | −0.0100 | −0.0200 | −0.0300 |
| t₁/(t₁ + t₃) | 0.0005 | 0.0050 | 0.0050 | 0.0050 | 0.0050 | 0.0050 | 0.0050 |
| L (1x) | 30664.61 | 30683.55 | 30674.16 | 30791.55 | 30767.74 | 30748.79 | 30938.68 |
| L/L0 | 1.000000 | 1.000618 | 1.000311 | 1.004140 | 1.003363 | 1.002745 | 1.008938 |

From Table 1 and Table 2, it can be seen that, the smaller the refractive index of the first glass layer (which is also referred to as the refractive index of the light emitting surface, hereinafter) is, the greater the brightness of the light from the glass plate 20A becomes. In the glass plate 20A where the first glass layer and the intermediate glass layer have predetermined thicknesses, respectively, the refractive index of the light emitting surface is preferably less than the refractive index of the internal glass plate, for example, by a value that is greater than or equal to 0.0005, so that the brightness of the light from the glass plate 20 can be increased. The refractive index of the light emitting surface is less than the refractive index of the internal glass plate by a value that is more preferably greater than or equal to 0.001, further more preferably greater than or equal to 0.005. Additionally, it can be seen from Table 1 that, even if the ratio of the thickness t₁ of the first glass layer with respect to the total thickness of the first glass layer and the intermediate glass layer is very small, such as 0.0005, the brightness can be enhanced.

Table 3 and Table 4 show the brightness ratio L/L0 of the light from the glass plate 20A for a case where the thickness t₁ of the first glass layer is set to be zero, namely, the case where the first glass layer does not exist. The brightness L of the light from the glass plate 20A is the average brightness of the rays with respective wavelengths extracted from the light emitting surface of the intermediate glass layer. The brightness ratio L/L0 is a normalized value obtained by setting the brightness L0 to be 1 for a case where the refractive index of the second glass layer is the same as the refractive index of the intermediate glass layer (n₂=n₃). The refractive index n₃ of the intermediate glass layer is set to be 1.520 for all wavelengths of the visible light.

TABLE 3

| | | | | | |
|---|---|---|---|---|---|
| n₂ − n₃ | 0.0000 | 0.0010 | 0.0050 | 0.0100 | 0.0200 |
| t₂/(t₂ + t₃) | 0.0005 | 0.0005 | 0.0005 | 0.0005 | 0.0005 |
| L (lx) | 30664.61 | 30711.67 | 30752.41 | 30752.45 | 30778.07 |
| L/L0 | 1.000000 | 1.001535 | 1.002863 | 1.003125 | 1.003700 |

TABLE 4

| | | | | | | |
|---|---|---|---|---|---|---|
| n₂ − n₃ | 0.0000 | 0.0005 | 0.0010 | 0.0100 | 0.0200 | 0.0300 |
| t₂/(t₂ + t₃) | 0.0005 | 0.0050 | 0.0050 | 0.0050 | 0.0050 | 0.0050 |
| L (1x) | 30664.61 | 30851.41 | 30706.82 | 30881.17 | 30985.92 | 30936.59 |
| L/L0 | 1.000000 | 1.006092 | 1.001377 | 1.007062 | 1.010478 | 1.008870 |

From Table 3 and Table 4, it can be seen that, the greater the refractive index of the second glass layer (which is also referred to as the refractive index of the light scattering surface, hereinafter) is, the greater the brightness of the light from the glass plate 20A becomes. In the glass plate 20A where the second glass layer and the intermediate glass layer have predetermined thicknesses, respectively, the refractive index of the light scattering surface is preferably greater than the refractive index of the internal glass plate, for example, by a value that is greater than or equal to 0.0005, so that the brightness of the light from the glass plate 20 can be increased. The refractive index of the light scattering surface is greater than the refractive index of the internal glass plate by a value that is more preferably greater than or equal to 0.001, further more preferably greater than or equal to 0.005. Additionally, it can be seen from Table 3 that, even if the ratio of the thickness t₂ of the second glass layer with respect to the total thickness of the second glass layer and the intermediate glass layer is very small, such as 0.0005, the brightness can be enhanced.

Table 5 shows the brightness ratio L/L0 of the light from the glass plate 20A for a case where the glass plate 20A has a two layer structure or a three layer structure. The brightness L of the light from the glass plate 20A is the average brightness of the rays with respective wavelengths extracted from the light emitting surface 21A. The brightness ratio L/L0 is a normalized value obtained by setting the brightness L0 to be 1 for a case where the refractive indexes of the first glass layer, the second glass layer, and the intermediate glass layer are the same (n₁=n₂=n₃). The refractive index n₃ of the intermediate glass layer is set to be 1.520 for all wavelengths of the visible light. Furthermore, the reflectance r₁ on the light emitting surface 21A, the reflectance r₂ on the light scattering surface 23A, and the difference of these values r₁−r₂ are noted, which are calculated by the formula (1). Note that the reflectance referred to herein is the value of the amount of the reflected light when the amount of the incident light is defined to be 1.

TABLE 5

| | | | | |
|---|---|---|---|---|
| n₁ − n₃ | 0.0000 | −0.0100 | 0.0000 | −0.0100 |
| n₂ − n₃ | 0.0000 | 0.0000 | 0.0100 | 0.0100 |
| n₁ − n₂ | 0.0000 | −0.0100 | −0.0100 | −0.0200 |
| t₁/(t₁ + t₂ + t₃) | 0.0050 | 0.0050 | 0.0050 | 0.0050 |
| t₂/(t₁ + t₂ + t₃) | 0.0050 | 0.0050 | 0.0050 | 0.0050 |
| L (lx) | 30664.61 | 30767.74 | 30881.17 | 30913.95 |
| L/L0 | 1.000000 | 1.003363 | 1.007062 | 1.008131 |
| r₁ | 0.04258 | 0.04129 | 0.04258 | 0.04129 |
| r₂ | 0.04258 | 0.04258 | 0.04388 | 0.04388 |
| r₁ − r₂ | 0.00000 | −0.00129 | −0.00130 | −0.00260 |

From Table 5, it can be seen that the brightness becomes maximum for a case where the refractive index of the first glass layer (i.e., the refractive index of the light emitting surface) is less than the refractive index of the intermediate glass layer, and the refractive index of the second glass layer (i.e., the refractive index of the light scattering surface) is greater than the refractive index of the intermediate glass layer. Furthermore, it can be seen that, when the refractive index of the light emitting surface becomes more smaller than the refractive index of the light scattering surface, the reflection from the light emitting surface toward inside is suppressed, and efficiency of extracting the light toward outside can be enhanced, so that the brightness is increased.

The refractive index calculated from the measured value of the reflectance of the light emitting surface 21A is preferably less than the refractive index calculated from the measured value of the reflectance of the light scattering surface 23A; and the refractive index calculated from the measured value of the reflectance of the light emitting surface 21A is preferably less than the refractive index calculated from the measured value of the reflectance of the light scattering surface 23 by a value that is more preferably greater than or equal to 0.010, further more preferably greater than or equal to 0.015, and particularly preferably greater than or equal to 0.020. Further, the reflectance of the light emitting surface 21A is preferably less than the reflectance of the light scattering surface 23A; and the reflectance of the light emitting surface 21A is preferably less than the reflectance of the light scattering surface 23A by a value that is more preferably greater than or equal to 0.0007, further more preferably greater than or equal to 0.0013, and particularly preferably greater than or equal to 0.0026. When the reflectance of the light emitting surface 21A is less than 0.042, the reflection of light on the light emitting surface 21A toward inside can be suppressed, so that it is preferable from the perspective that the efficiency of extracting light toward outside can be enhanced. When the reflectance of the light scattering surface 23A is greater than 0.043, the reflection of light on the light scattering surface 23A toward inside can be promoted, so that it is preferable from the perspective that the efficiency of extracting light toward outside can be enhanced.

The embodiment of the glass plate for the light guide plate and the liquid crystal display are described above; however, the present invention is not limited to the above-described embodiment, and various modifications and improvements may be made within the scope of the gist of the present invention described in the claims.

For example, the liquid crystal display according to the above-described embodiment is a transmission type; however, the liquid crystal display may be a reflection type, and the glass plate 20 may be located in front of the liquid crystal panel 10. Light from the light source 30 enters the inner part from the edge surface of the glass plate 20; the light exits from the surface (the rear surface) of the glass plate 20 facing the liquid crystal panel 10; and the light uniformly illuminates the liquid crystal panel 10 from the front.

Further, in the above-described embodiment, the light source is the white LED; however, the light source may be a fluorescent tube. Furthermore, the type of the white LED is not particularly limited; and, for example, instead of the blue LED, an ultra violet LED whose wavelength is shorter than the wavelength of the blue LED may be used to cause a fluorophore to emit light. Furthermore, instead of the fluorophore-based white LED, a three-color LED based white LED may be used.

Further, the glass plate according to the above-described embodiment is molded by the float method; however, the molding method may be a fusion method, for example. In the fusion method, melted glass overflowing from a gutter-shaped member toward left and right is caused to flow downward along left and right side surfaces of the gutter-shaped member; the flows of the melted glass are caused to merge in the vicinity of a lower end of the gutter-shaped member where the left and right side surfaces intersect; and the melted glass is molded to have a band plate shape. For the case of the fusion method, the refractive index distribution in the plate thickness direction can be adjusted, for example, by adjusting the amount of the SO₂ that is sprayed during annealing.

A chemical composition of the glass plate for the light guide plate may be diverse; however, the following three types (glass provided with a glass composition A, a glass composition B, and a glass composition C) are typical examples. Note that the glass composition of the glass according to the present invention is not limited to the examples of the glass composition shown here.

A glass plate having the glass composition A preferably includes, in terms of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; and 5 ppm to 100 ppm Fe₂O₃. The refractive index of this glass with respect to d-ray of helium (the wavelength is 587.6 nm) at room temperature is from 1.45 to 1.60. As specific examples, there are examples 1 to 4, and example 15 of Table 6.

Further, a glass plate having the glass composition B preferably includes, in terms of mass percentage on a basis of oxide, 45% to 80% SiO₂; greater than 7% and less than or equal to 30% Al₂O₃; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃. The refractive index of this glass with respect to d-ray of helium (the wavelength is 587.6 nm) at room temperature is from 1.45 to 1.60. With this glass composition, ion exchange can be easily performed, and chemical strengthening can be easily performed. As specific examples, there are examples 5 to 11 of Table 6.

Further, a glass plate having the glass composition C preferably includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃. The refractive index of this glass with respect to d-ray of helium (the wavelength is 587.6 nm) at room temperature is from 1.45 to 1.60. As specific examples, there are examples 12 to 14 of Table 6.

For the glass plate according to the embodiment of the present invention including the above-described components, the composition ranges of the components of the glass composition are described below.

SiO₂ is a main component of the glass.

In order to maintain a weather resistance property and a devitrification property of the glass, the content of SiO₂ for the glass composition A in terms of mass percentage on a basis of oxide is preferably greater than or equal to 60%, and more preferably greater than or equal to 63%; the content of SiO₂ for the glass composition B in terms of mass percentage on a basis of oxide is preferably greater than or equal to 45%, and more preferably greater than or equal to 50%; and the content of SiO₂ for the glass composition C in terms of mass percentage on a basis of oxide is preferably greater than or equal to 45%, and more preferably greater than or equal to 50%.

However, in order to facilitate dissolution and to enhance foam quality, and in order to keep the content of ferrous (Fe²⁺) in the glass to be low, so that the optical property becomes favorable, the content of SiO₂ for the glass composition A in terms of mass percentage on a basis of oxide is preferably less than or equal to 80%, and more preferably less than or equal to 75%; the content of SiO₂ for the glass composition B in terms of mass percentage on a basis of oxide is preferably less than or equal to 80%, and more preferably less than or equal to 70%; and the content of SiO₂ for the glass composition C in terms of mass percentage on a basis of oxide is preferably less than or equal to 70%, and more preferably less than or equal to 65%.

For the glass compositions B and C, Al₂O₃ is an essential component to enhance the weather resistance property of the glass. In order to maintain a practically required weather resistance property of the glass according to the embodiment, the content of Al₂O₃ for the glass composition A is preferably greater than or equal to 1%, more preferably greater than or equal to 2%; the content of Al₂O₃ for the glass composition B is preferably greater than 7%, more preferably greater than or equal to 10%; and the content of Al₂O₃ for the glass composition C is preferably greater than or equal to 10%, more preferably greater than or equal to 13%.

However, in order to keep the content of ferrous (Fe²⁺) to be low, so that the optical property becomes favorable and foam quality becomes favorable, the content of Al₂O₃ for the glass composition A is preferably less than or equal to 7%, and more preferably less than or equal to 5%; the content of Al₂O₃ for the glass composition B is preferably less than or equal to 30%, and more preferably less than or equal to 23%; and the content of Al₂O₃ for the glass composition C is preferably less than or equal to 30%, and more preferably less than or equal to 20%.

Ba₂O₃ is a component for promoting melting of the glass materials, so that a mechanical property and the weather resistance property are enhanced; however, in order to prevent generation of a ream by volatilization, and to prevent occurrence of inconvenience, such as corrosion of a furnace wall, the content of Ba₂O₃ for the glass composition A is preferably less than or equal to 5%, and more preferably less than or equal to 3%; and the content of Ba₂O₃ for the glass compositions B and C is preferably less than or equal to 15%, and more preferably less than or equal to 12%.

The alkali metal oxides, such as Li₂O, Na₂O, and K₂O, are useful components for promoting melting of the glass materials, and for adjusting thermal expansion, viscosity, and so forth of the glass materials. Thus, the content of Na₂O for the glass composition A is preferably greater than or equal to 3%, and more preferably greater than or equal to 8%. The content of Na₂O for the glass composition B is preferably greater than or equal to 7%, and more preferably greater than or equal to 10%. However, in order to maintain the clarity during melting, and to maintain the foam quality of the glass to be produced, the content of Na₂O for the glass compositions A and B is preferably less than or equal to 20%, and more preferably less than or equal to 15%; and the content of Na₂O for the glass composition C is preferably less than or equal to 3%, and more preferably less than or equal to 1%. Further, the content of K₂O for the glass compositions A and B is preferably less than or equal to 10%, and more preferably less than or equal to 7%; and the content of K₂O for the glass composition C is preferably less than or equal to 2%, and more preferably less than or equal to 1%. Further, though Li₂O is an optional component, less than or equal to 2% Li₂O may be included in the glass compositions A, B, and C, so as to facilitate vitrification, to suppress the iron content contained as impurities derived from raw materials to be a low level, and to reduce the batch cost to be low. Furthermore, in order to maintain the clarity during melting, and to maintain the foam quality of the glass to be produced, the total content of these alkali metal oxides (Li₂O+Na₂O+K₂O) for the glass compositions A and B is preferably from 5% to 20%, and more preferably from 8% to 15%; and the total content of these alkali metal oxides (Li₂O+Na₂O+K₂O) for the glass composition C is preferably from 0% to 2%, and more preferably from 0% to 1%.

The alkali earth metal oxides, such as MgO, CaO, SrO, and BaO, are useful components for promoting melting of the glass materials, and for adjusting thermal expansion, viscosity, and so forth of the glass materials. MgO has an effect to promote melting by lowering viscosity during melting of the glass. In addition, MgO has an effect to reduce a specific gravity, and to prevent the glass plate from being scratched, so that MgO may be included in the glass compositions A, B, and C. Furthermore, the content of MgO for the glass composition A is preferably less than or equal to 10%, and more preferably less than or equal to 8%; the content of MgO for the glass composition B is preferably less than or equal to 15%, and more preferably less than or equal to 12%; and the content of MgO for the glass composition C is preferably less than or equal to 10%, and more preferably less than or equal to 5%, so that the thermal expansion coefficient of the glass can be small and the devitrification property can be favorable.

Since CaO is a component that promotes melting of the glass materials, and that adjusts viscosity, thermal expansion, and so forth of the glass materials, CaO may be included in the glass compositions A, B, and C. In order to obtain the above-described effects, the content of CaO for the glass composition A is preferably greater than or equal to 3%; and more preferably greater than or equal to 5%. Additionally, in order to improve the devitrification, the content of CaO for the glass composition A is preferably less than or equal to 20%, and more preferably less than or equal to 10%; and the content of CaO for the glass composition B is preferably less than or equal to 6%, and more preferably less than or equal to 4%.

SrO has an effect to increase the thermal expansion coefficient, and to lower high-temperature viscosity of the glass. In order to obtain such effects, SrO may be included in the glass compositions A, B, and C. However, in order to suppress the thermal expansion coefficient to be small, the content of SrO for the glass compositions A and C is preferably less than or equal to 15%, and more preferably less than or equal to 10%; and the content of SrO for the glass composition B is preferably less than or equal to 5%, and more preferably less than or equal to 3%.

Similar to SrO, BaO has an effect to increase the thermal expansion coefficient, and to lower high-temperature viscosity of the glass. In order to obtain the above-described effects, BaO may be included in the glass. However, in order to suppress the thermal expansion coefficient to be small, the content of BaO for the glass compositions A and C is preferably less than or equal to 15%, and more preferably less than or equal to 10%; and the content of BaO for the glass composition B is preferably less than or equal to 5%, and more preferably less than or equal to 3%.

Furthermore, in order to suppress the thermal expansion coefficient to be small, to make the devitrification property favorable, and to maintain robustness, the total content of these alkali earth metal oxides (MgO+CaO+SrO+BaO) for the glass composition A is preferably from 10% to 30%, and more preferably from 13% to 27%; the total content of these alkali earth metal oxides (MgO+CaO+SrO+BaO) for the glass composition B is preferably from 1% to 15%, and more preferably from 3% to 10%; and the total content of these alkali earth metal oxides (MgO+CaO+SrO+BaO) for the glass composition C is preferably from 5% to 30%, and more preferably from 10% to 20%.

In the glass composition of the glass of the glass plate according to the embodiment of the present invention, in order to enhance the heat resistance and surface hardness of the glass, each of the glass compositions A, B, and C may include less than or equal to 10% ZrO₂, preferably less than or equal to 5% ZrO₂, as an optional component. However, if the content of ZrO₂ exceeds 10%, the glass tends to devitrify, so that it is not preferable that the content of ZrO₂ exceeds 10%.

In the glass composition of the glass of the glass plate according to the embodiment of the present invention, in order to enhance the melting property of the glass, each of the glass compositions A, B, and C may include 5 ppm to 100 ppm Fe₂O₃. Here, the content of Fe₂O₃ refers to the whole quantity of iron oxide in terms of Fe₂O₃. The whole quantity of iron oxide is preferably from 5 ppm by mass to 50 ppm by mass, and more preferably from 5 ppm by mass to 30 ppm by mass. If the above-described whole quantity of iron oxide is less than 5 ppm, the infrared light absorption property of the glass is extremely deteriorated, it becomes difficult to enhance the melting property of the glass, and a large cost is required to purify the raw materials, so that it is not preferable that the whole quantity of iron oxide be less than 5 ppm. Furthermore, if the whole quantity of iron oxide exceeds 100 ppm, coloration of the glass becomes significant, and the visible light transmittance is reduced, so that it is not preferable that the whole quantity of iron oxide exceed 100 ppm.

Further, the glass of the glass plate according to the embodiment of the present invention may include SO₃, as a clarifying agent. In this case, the content of SO₃, in terms of mass percentage, is preferably greater than 0% and less than or equal to 0.5%. The content of SO₃ is more preferably less than or equal to 0.4%, further more preferably less than or equal to 0.3%, and particularly preferably less than or equal to 0.25%.

Further, the glass of the glass plate according to the embodiment of the present invention may include one or more of Sb₂O₃, SnO₂, and As₂O₃, as an oxidizing agent and a clarifying agent. In this case, the content of Sb₂O₃, SnO₂, and As₂O₃, in terms of mass percentage, is preferably from 0% to 0.5%. The content of Sb₂O₃, SnO₂, and As₂O₃ is more preferably less than or equal to 0.2%, and further more preferably less than or equal to 0.1%; and it is further more preferable that Sb₂O₃, SnO₂, and As₂O₃ be substantially not included. However, Sb₂O₃, SnO₂, and As₂O₃ affect as the oxidizing agent of the glass, so that Sb₂O₃, SnO₂, and As₂O₃ may be added within the above-described range so as to adjust the amount of Fe²⁺ of the glass. However, As₂O₃ may not be positively included due to environmental concern.

Furthermore, the glass of the glass plate according to the embodiment of the present invention may include NiO. When NiO is included, NiO functions as a coloring component, so that the content of NiO is preferably less than or equal to 100 ppm with respect to the total amount of the glass composition described above. In particular, from the viewpoint that NiO does not cause the internal transmittance of the glass plate at a wavelength from 400 nm to 700 nm to be lowered, the content of NiO is preferably less than or equal to 1.0 ppm, and more preferably less than or equal to 0.5 ppm.

Furthermore, the glass of the glass plate according to the embodiment of the present invention may include Cr₂O₃. When Cr₂O₃ is included, Cr₂O₃ functions as a coloring component, so that the content of Cr₂O₃ is preferably less than or equal to 10 ppm with respect to the total amount of the glass composition described above. In particular, from the viewpoint that Cr₂O₃ does not cause the internal transmittance of the glass plate at a wavelength from 400 nm to 700 nm to be lowered, the content of Cr₂O₃ is preferably less than or equal to 1.0 ppm, and more preferably less than or equal to 0.5 ppm.

The glass of the glass plate according to the embodiment of the present invention may include MnO₂. When MnO₂ is included, MnO₂ functions as a component that absorbs visible light, so that the content of MnO₂ is preferably less than or equal to 50 ppm with respect to the total amount of the glass composition described above. In particular, from the viewpoint that MnO₂ does not cause the internal transmittance of the glass plate at a wavelength from 400 nm to 700 nm to be lowered, the content of MnO₂ is preferably less than or equal to 10 ppm.

The glass of the glass plate according to the embodiment of the present invention may include TiO₂. When TiO₂ is included, TiO₂ functions as a component that absorbs visible light, so that the content of TiO₂ is preferably less than or equal to 1000 ppm with respect to the total amount of the glass composition described above. In particular, from the viewpoint that TiO₂ does not cause the internal transmittance of the glass plate at a wavelength from 400 nm to 700 nm to be lowered, the content of TiO₂ is preferably less than or equal to 500 ppm, and more preferably less than or equal to 100 ppm.

The glass of the glass plate according to the embodiment of the present invention may include CeO₂. CeO₂ has an effect to decelerate the Redox (the reduction-oxidation reaction) of iron, and CeO₂ can reduce the absorption of the glass at a wavelength from 400 nm to 700 nm. However, if a large amount of CeO₂ is included, CeO₂ also functions as a component to absorb visible light, and CeO₂ may lower the Redox of iron to be less than 3%, so that it is not preferable that the large amount of CeO₂ be included. Thus, the content of CeO₂ is preferably less than or equal to 1000 ppm with respect to the total amount of the glass composition described above. Furthermore, the content of CeO₂ is more preferably less than or equal to 500 ppm, further more preferably less than or equal to 400 ppm, particularly preferably less than or equal to 300 ppm, and most preferably less than or equal to 250 ppm.

The glass of the glass plate according to the embodiment of the present invention may include at least one component selected from a group formed of CoO, V₂O₅, and CuO. When CoO, V₂O₅, and CuO are included, CoO, V₂O₅, and CuO function as components for absorbing visible light, so that the content of CoO, V₂O₅, and CuO is preferably less than or equal to 10 ppm with respect to the total amount of the glass composition described above. In particular, it is preferable that CoO, V₂O₅, and CuO be substantially not included in the glass, so that the internal transmittance of the glass plate for a wavelength from 400 nm to 700 nm is not lowered.

TABLE 6

| | | | | | | | | | | ex. | ex. | ex. | ex. | ex. | ex. |
|---|---|---|---|---|---|---|---|---|---|---|---|---|---|---|---|
| | ex. 1 | ex. 2 | ex. 3 | ex. 4 | ex. 5 | ex. 6 | ex. 7 | ex. 8 | ex. 9 | 10 | 11 | 12 | 13 | 14 | 15 |
| SiO₂ | 72.0 | 71.8 | 68.5 | 57.5 | 52.0 | 61.0 | 65.0 | 65.0 | 58.5 | 56.0 | 62.0 | 60.0 | 60.0 | 62.0 | 69.8 |
| (mass %) | | | | | | | | | | | | | | | |
| B₂O₃ | — | — | — | — | — | — | — | — | 5.0 | 2.0 | — | 8.0 | 10.0 | 11.0 | — |
| (mass %) | | | | | | | | | | | | | | | |
| Al₂O₃ | 1.5 | 1.0 | 5.0 | 7.0 | 12.0 | 13.0 | 16.0 | 14.0 | 22.0 | 13.0 | 19.0 | 17.0 | 15.0 | 17.0 | 3.0 |
| (mass %) | | | | | | | | | | | | | | | |
| Li₂O | — | — | — | — | — | — | — | — | — | — | — | — | — | — | — |
| (mass %) | | | | | | | | | | | | | | | |
| Na₂O | 13.5 | 13.6 | 14.5 | 4.5 | 6.0 | 12.0 | 14.0 | 13.7 | 13.4 | 15.0 | 14.0 | — | — | — | 11.0 |
| (mass %) | | | | | | | | | | | | | | | |
| K₂O | — | — | 0.5 | 6.0 | 4.0 | 6.0 | — | 2.0 | — | 5.0 | 1.7 | — | — | — | — |
| (mass %) | | | | | | | | | | | | | | | |
| MgO | 4.0 | 4.0 | 4.0 | 2.0 | 0.2 | 7.0 | 5.0 | 4.5 | 1.0 | 2.0 | 3.0 | 3.0 | 0.1 | 1.0 | — |
| (mass %) | | | | | | | | | | | | | | | |
| CaO | 8.5 | 9.0 | 7.0 | 5.0 | 5.0 | — | — | 0.5 | — | 2.0 | — | 4.0 | 5.4 | 7.5 | 8.0 |
| (mass %) | | | | | | | | | | | | | | | |
| SrO | — | — | — | 7.0 | 12.1 | — | — | — | — | — | — | 7.7 | 5.7 | 0.9 | 4.0 |
| (mass %) | | | | | | | | | | | | | | | |
| BaO | — | — | — | 8.0 | 3.5 | — | — | — | — | — | — | — | 3.5 | 0.5 | 4.0 |
| (mass %) | | | | | | | | | | | | | | | |
| ZrO₂ | — | — | — | 3.0 | 5.0 | 1.0 | — | 0.1 | — | 4.5 | — | — | — | — | — |
| (mass %) | | | | | | | | | | | | | | | |
| TiO₂ | 0.1 | — | 0.1 | — | 0.1 | — | — | — | — | — | — | — | — | — | — |
| (mass %) | | | | | | | | | | | | | | | |
| SnO₂ | — | — | — | — | — | — | — | — | — | 0.3 | 0.2 | — | 0.2 | 0.1 | — |
| (mass %) | | | | | | | | | | | | | | | |
| SO₃ | 0.4 | 0.4 | 0.4 | — | 0.1 | — | — | 0.2 | 0.1 | — | — | — | 0.1 | — | 0.2 |
| (mass %) | | | | | | | | | | | | | | | |
| Sb₂O₃ | — | 0.2 | — | — | — | — | — | — | — | 0.1 | — | 0.2 | — | — | — |
| (mass %) | | | | | | | | | | | | | | | |
| Cl | — | — | — | — | — | — | — | — | — | 0.1 | 0.1 | 0.1 | — | — | — |
| (mass %) | | | | | | | | | | | | | | | |
| Fe₂O₃ | 50 | 50 | 50 | 50 | 50 | 50 | 50 | 50 | 50 | 50 | 50 | 50 | 50 | 50 | 28 |
| (mass | | | | | | | | | | | | | | | |
| ppm) | | | | | | | | | | | | | | | |
| CeO₂ | — | — | — | — | — | — | — | — | — | — | — | — | — | — | 200 |
| (mass | | | | | | | | | | | | | | | |
| ppm) | | | | | | | | | | | | | | | |
| n_{d} | 1.52 | 1.52 | 1.52 | 1.55 | 1.55 | 1.51 | 1.50 | 1.51 | 1.50 | 1.51 | 1.50 | 1.52 | 1.52 | 1.51 | 1.52 |

1. A glass plate for a light guide plate comprising:
a light emitting surface; and
a light scattering surface that is opposite to the light emitting surface,
wherein a refractive index distribution is provided between the light emitting surface and the light scattering surface in a plate thickness direction, and
wherein a refractive index calculated from a measured value of reflectance of the light scattering surface is greater than a refractive index of an inner part of the glass plate that is measured by a V block method after each of the light emitting surface and the light scattering surface is polished and removed by 100 microns.

2. The glass plate for the light guide plate according to claim 1, wherein a refractive index calculated from a measured value of reflectance of the light emitting surface is less than the refractive index of the inner part of the glass plate that is measured by the V block method after each of the light emitting surface and the light scattering surface is polished and removed by 100 microns.

3. A glass plate for a light guide plate comprising:
a light emitting surface; and
a light scattering surface that is opposite to the light emitting surface,
wherein a refractive index distribution is provided between the light emitting surface and the light scattering surface in a plate thickness direction, and
wherein a refractive index calculated from a measured value of reflectance of the light emitting surface is less than a refractive index of an inner part of the glass plate that is measured by a V block method after each of the light emitting surface and the light scattering surface is polished and removed by 100 microns.

4. A glass plate for a light guide plate comprising:
a light emitting surface; and
a light scattering surface that is opposite to the light emitting surface,
wherein reflectance of the light emitting surface is less than reflectance of light scattering surface.

5. The glass plate for the light guide plate according to claim 4, wherein the reflectance of the light emitting surface at a wavelength 587.6 nm is less than 0.042.

6. The glass plate for the light guide plate according to claim 4, wherein the reflectance of the light emitting surface at a wavelength 587.6 nm is less than 0.043.

7. The glass plate for the light guide plate according to claim 1, wherein the glass plate includes, in terms of mass percentage on a basis of oxide, 60% to 80% SiO₂; 0% to 7% Al₂O₃; 0% to 10% MgO; 0% to 20% CaO; 0% to 15% SrO; 0% to 15% BaO; 3% to 20% Na₂O; 0% to 10% K₂O; and 5 ppm to 100 ppm Fe₂O₃.

8. The glass plate for the light guide plate according to claim 1, wherein the glass plate includes, in terms of mass percentage on a basis of oxide, 45% to 80% SiO₂; greater than 7% and less than or equal to 30% Al₂O₃; 0% to 15% B₂O₃: 0% to 15% MgO; 0% to 6% CaO; 0% to 5% SrO; 0% to 5% BaO; 7% to 20% Na₂O; 0% to 10% K₂O; 0% to 10% ZrO₂; and 5 ppm to 100 ppm Fe₂O₃.

9. The glass plate for the light guide plate according to claim 1, wherein the glass plate includes, in terms of mass percentage on a basis of oxide, 45% to 70% SiO₂; 10% to 30% Al₂O₃; 0% to 15% B₂O₃: 5% to 30% MgO, CaO, SrO, and BaO in total; greater than or equal to 0% and less than 3% Li₂O, Na₂O, and K₂O in total; and 5 ppm to 100 ppm Fe₂O₃.
